(19) United States
(12) Patent Application Publication
(10) Pub. No.: US 2014/0300926 A1
(43) Pub. Date: Oct. 9, 2014

(54) METHODS AND SYSTEMS FOR AUTOMATIC SELECTION OF A PRODUCTION DEVICE CONFIGURATION IN A PRODUCTION ENVIRONMENT

(71) Applicant: Xerox Corporation, Norwalk, CT (US)

(72) Inventors: Sudhendu Rai, Fairport, NY (US); Ranjit Kumar Ettam, Andhra (IN); Marc Dennis Daniels, Webster, NY (US); Timothy Wayne Jacobs, Fairport, NY (US)

(73) Assignee: Xerox Corporation, Norwalk, CT (US)

(21) Appl. No.: 14/023,863

(22) Filed: Sep. 11, 2013

Related U.S. Application Data
(60) Provisional application No. 61/809,950, filed on Apr. 9, 2013.

(51) Int. Cl. G06F 3/12; G06Q 10/06

(52) U.S. Cl. CPC G06F 3/1211; G06Q 10/0639
USPC 358/1.15

(57) ABSTRACT

A method of determining a configuration of production devices in a print production environment may include receiving, by a computing device, one or more production environment characteristics associated with a print production environment, receiving job processing information, identifying, by the computing device, a performance measure, receiving a desired value associated with the identified performance measure, receiving one or more parameters associated with a random search algorithm, and performing, by the computing device, the random search algorithm based on at least the received job processing information and the received parameters to determine a configuration of production devices in the print production environment that satisfies the desired value associated with the performance measure.

### CROSS-REFERENCE TO RELATED APPLICATIONS

This application claims priority to U.S. Patent Application 61/809,950, filed on Apr. 9, 2013, the entirety of which is included herein by reference.

### BACKGROUND

Print shops are document manufacturing systems that manufacture document-based products or items. The cost and performance metrics of a print shop typically depend on the equipment type and numbers and the associated production processes in a very complex manner. This makes optimizing production device and production environment configurations difficult.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of determining a configuration of production devices in a print production environment may include receiving, by a computing device, one or more production environment characteristics associated with a print production environment, receiving job processing information, identifying, by the computing device, a performance measure, receiving a desired value associated with the identified performance measure, receiving one or more parameters associated with a random search algorithm, and performing, by the computing device, the random search algorithm based on at least the received job processing information and the received parameters to determine a configuration of production devices in the print production environment that satisfies the desired value associated with the performance measure.

In an embodiment, a system of determining a configuration of production devices in a print production environment may include a computing device and a computer-readable storage medium in communication with the computing device. The computer-readable storage medium may include one or more programming instructions that, when executed, cause the computing device to receive one or more production environment characteristics associated with a print production environment, receive job processing information, identify a performance measure, receive a desired value associated with the identified performance measure, receive one or more parameters associated with a random search algorithm, and perform the random search algorithm based on at least the received job processing information and the received parameters to determine a configuration of production devices in the print production environment that satisfies the desired value associated with the performance measure.

In an embodiment, a system of determining a configuration of production devices in a print production environment may include a computing device and a computer-readable storage medium in communication with the computing device. The computer-readable storage medium may include one or more programming instructions that, when executed, cause the computing device to receive one or more production environment characteristics associated with a print production environment, receive job processing information, receive one or more parameters associated with a random search algorithm, perform the random search algorithm using a plurality of simulations to determine one or more performance measures based on at least the received job processing information and the received parameters, and determining, based on the one or more performance measures, a configuration of production devices in the print production environment that satisfies one or more desired values associated with the one or more performance measures.

### BRIEF DESCRIPTION OF THE DRAWINGS

FIG. 1 illustrates an example of a production environment according to an embodiment.

FIG. 2 illustrates a flow chart of an example method of determining a configuration of production devices in a production environment using a random search algorithm according to an embodiment.

FIG. 3 illustrates an example histogram of the average turnaround time according to an embodiment.

FIG. 4 illustrates an example histogram of the maximum turnaround time according to an embodiment.

FIG. 5 illustrates an example histogram of the number of late jobs according to an embodiment.

FIG. 6 illustrates a block diagram of example hardware that may be used to contain or implement program instructions according to an embodiment.

### DETAILED DESCRIPTION

The following terms shall have, for purposes of this application, the respective meanings set forth below:

A “cell” refers to one or more production devices in a production environment that are capable of processing at least a portion of a job. For example, in a print production environment, a cell may include one or more print production devices that are capable of processing at least a portion of a print job.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “job” refers to a logical unit of work that is to be completed for a customer. For example, in a print production environment, a job may include one or more print jobs from one or more clients. For example, a job in a vehicle production environment may include manufacturing a vehicle or a portion thereof. As another example, a job in a chemical production environment may include producing or processing a chemical product or a portion thereof. Similarly, a job in a computing device production environment may be to manufacture a computing device or a portion thereof such as, for example, a printer, a scanner or a copier.

A “print job” refers to a job processed in a print shop. For example, a print job may include a series of processing steps for producing credit card statements corresponding to a certain credit card company, producing bank statements corresponding to a certain bank, printing a document, or the like. In this document, a print job may refer to the set of instructions that cause the items to be produced or printed, as well as the work-in-progress and produced items themselves. Although the disclosed embodiments pertain to print jobs, the disclosed methods and systems can be applied to jobs in general in other production environments, such as automotive manufacturing, semiconductor production and the like.

A “production device” refers to a device that is capable of processing at least a portion of a job. For example, in a print production environment, an example production device may include, without limitation, a printer, scanner, collator, binder, hole punch and/or the like.

A “production environment” refers to machine and/or human labor used to complete one or more jobs. A production environment may include one or more production devices or other equipment that may be used to complete one or more jobs. Example production environments may include, without limitation, a print production environment, a chemical production environment, a vehicle production environment, a computing device manufacturing production environment, and/or other manufacturing production environments.

Software and systems, such as, for example, Xerox's Lean Document Production (LDP) solution, may enable modeling of complex print production environments under a cellular production framework. For example, the software toolkit described in Rai, Duke, Lowe, Quan-Trotter and Scheermesser 2009, LDP Lean Document Production—O.R.—Enhanced Productivity Improvements for the Printing Industry, Interfaces Vol. 39, No. 1, January-February 2009, pp. 69-90, involves automating steps of a modeling process by generating complex simulation models that are used to determine improved design and operating points for print shops.

A production environment and the work flowing through it may be modeled to gain an understanding of the production environment's current state. One or more simulations of production environment operations may be performed to determine one or more parameters needed to achieve a desired state. One or more simulations may be used to identify opportunities to increase the overall productivity of production environments through the positioning of production devices and operators, changes in workflow routing, cross-training of production device operators and/or the like.

The methods and systems described in this document generally relate to performing a random search algorithm to enable automated search of a large number of design alternatives in the presence of operational constraints to determine a cost-optimal solution for a production environment, such as, for example, a print production environment. For example, simulated annealing may be performed to determine optimal or near-optimal solutions when simulation output is normal or non-normally distributed. An automated method that uses a random search technique, such as an optimization technique, may be used to determine the most cost-effective production environment configuration that meets the production environment's performance goals.

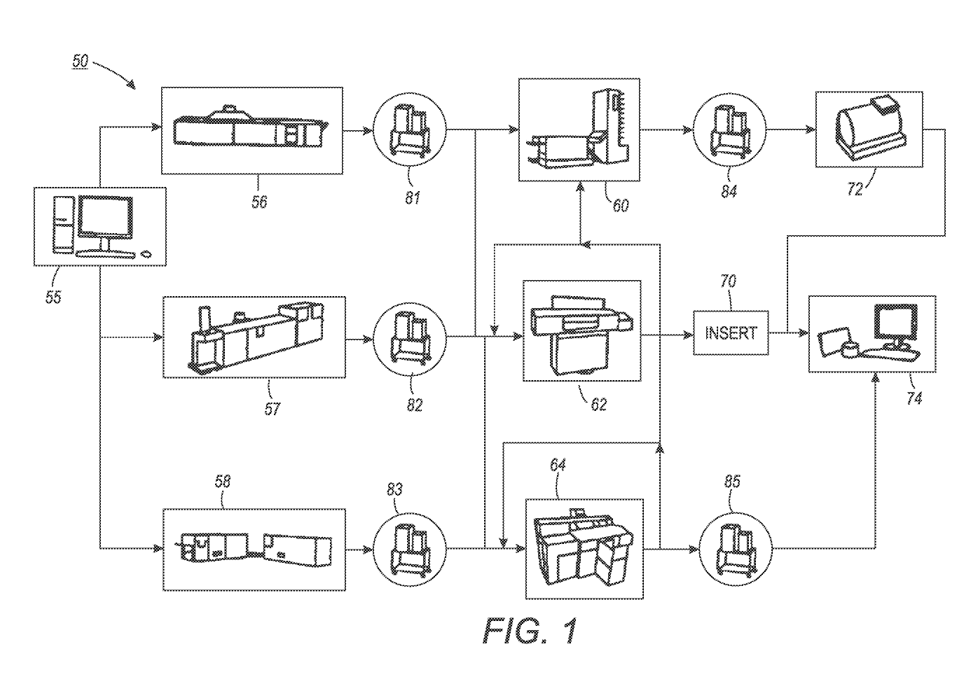

FIG. 1 shows an example of a production environment 50, in this case, example elements of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85.

In an embodiment, the problem of selecting an optimal production device configuration that meets one or more production environment performance goals may be mathematically illustrated as follows:

$$Objective \text{:} {min}_{{X}_{k} ∈ S} {f}_{0} ( {X}_{k} ) \\ Subject To \text{:} {f}_{1} ( {X}_{k} ) \leq δ \\ {X}_{k} = [ {x}_{ij} ] , k = 1 … \vert S \vert , \vert {X}_{k} \vert = {\sum }_{j = 1}^{W} {n}_{j} \\ l b \leq {x}_{ij} \leq ub , i = 1 … {n}_{j} , j = 1 … W \qquad ( 1 )$$

where:

S represents the search space, and comprises a large, finite and discrete set of design configurations;

Xₖ is the k^{th} design configuration, which includes a combination of different types of production devices;

xᵢⱼ represents the number of i^{th} type of production device in the j^{th} cell;

Nⱼ represents the number of unique types of production device in cell j;

W represents the number of cells in the production environment;

lb represents the lower bound for each unique type of production device;

ub represents the upper bound for each unique type of production device;

ƒ₀(Xₖ) represents the primary performance measure of interest;

ƒ₁(Xₖ) represents the secondary performance measure of interest; and

δ represents the maximum desirable level for secondary performance measures.

In an embodiment, the performance measures may not have a closed form and, as such, may be evaluated via simulation. If V₁ₖ is the stochastic simulation output for design Xₖ, then the performance measure may be estimated as an expectation of this variable. For example, performance measure f₁(Xₖ) may be estimated as ƒ₁(Xₖ)=E[V₁ₖ].

In an embodiment, one or more random search algorithms that are adapted for a stochastic environment associated with discrete-event simulation optimization may be used to determine an optimal production device configuration for a production environment. A random search algorithm may be one that uses a type of randomness, such as, for example, a pseudo-random number generator. Example random search algorithms may include, without limitation, simulated annealing, tabu search, clustering algorithms, cross-entropy, genetic algorithms, particle swarm optimization, evolutionary programming, stochastic approximation, multi-start, and ant colony optimization.

A random search algorithm may search the design space to determine the most cost-effective production device configuration by automatically running multiple simulations and selecting the best solution. This automated procedure alleviates the need for manual operator intervention during the simulation iterations, and it provides a faster and more efficient solution than a manual approach.

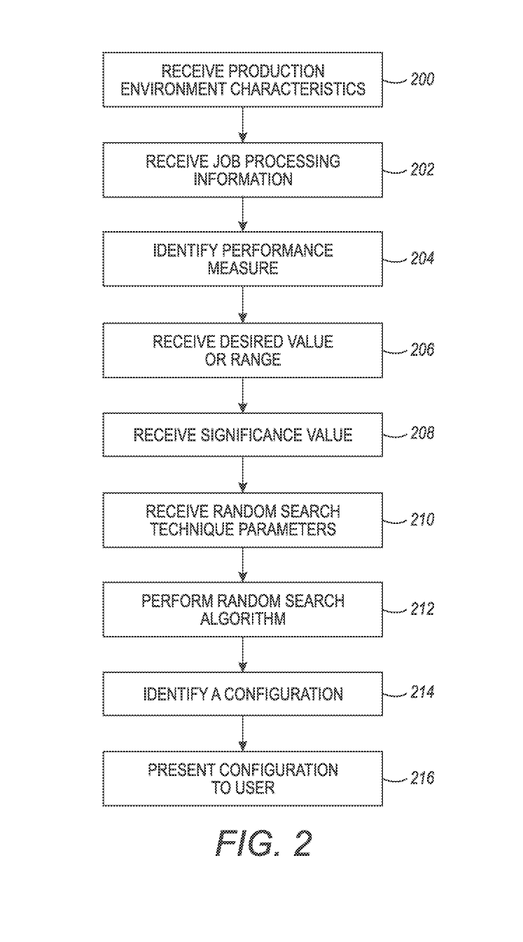

FIG. 2 illustrates a flow chart of an example method of determining a configuration of production devices in a production environment using a random search algorithm, such as annealing, according to an embodiment. As illustrated by FIG. 2, one or more production environment characteristics associated with one or more cells may be received 200.

A production environment characteristic may refer to a characteristic associated with the operation of a production environment. Example production environment characteristics may include, without limitation, a number of production devices, one or more types of production devices, a number or a numerical range of a particular type of production device, one or more setup characteristics, a job mix variability, a cost and/or other operating conditions. In an embodiment, one or more production environment characteristics may be received 200 from a user, from one or more production devices, from one or more computing devices and/or the like.

In an embodiment, job processing information may be received 202. Job processing information may include characteristics about one or more jobs to be processed by a production environment such as, for example, a job type, a job volume associated with one or more production steps, one or more attributes associated with a job step (e.g., type of form on which the job needs to be printed), job arrival time, due time and/or the like.

In an embodiment, job processing information may include one or more operating policies associated with the production environment. An operating policy may include one or more operating conditions that specify the sequence in which the jobs are to be processed. For example, a release control policy may specify the number of jobs that are released into a production environment at a given time. A lot-splitting policy may specify how many lots the jobs are to be split into for concurrent processing on multiple devices. In an embodiment, a batching policy may specify how jobs may be grouped based on similar characteristics (e.g., printing on the same form type). A batching policy may specify how jobs may be grouped based on similar characteristics (e.g., printing on the same form type). A routing policy may specify the cells and/or production devices to which the jobs are to be routed.

In an embodiment, one or more performance measures may be identified 204. A performance measure may be an operational parameter associated with a production environment. Example performance measures may include, without limitation, a mean turnaround time, cost, throughput, number of late jobs and/or the like. In an embodiment, a performance measure may be identified 204 by a user.

In an embodiment, a desired value or range of values associated with a performance measure may be received 206. In an embodiment, a desired value or range of values may be received 206 from a user. A desired value or range of values may include, without limitation, a minimum value, a maximum value, an average value and/or the like associated with a performance measure. For example, a user may specify a maximum value of a performance measure associated with a cell or a production environment. For instance, if a performance measure is turnaround time, a user may specify that the maximum value associated with turnaround time is 10 hours. Additional and/or alternate values and/or types of values may be used within the scope of this disclosure.

In an embodiment, a significance value associated with a test may be received 208. A significance value may be received 208 from a user, a computing device, a computer-readable memory and/or the like.

In an embodiment, one or more random search technique parameters may be received 210. A random search technique parameter may be one or more parameters used in a random search algorithm. In an embodiment, example random search technique parameters for annealing may include, without limitation, a number of times to run a simulation on a design, a temperature depth, a temperature decay rate, a number of times to search a neighborhood solution at a given annealing temperature and/or the like.

In an embodiment, a random search algorithm may be performed 212. For example, a modified simulated annealing algorithm may be performed 212. Performing a modified simulated annealing algorithm may identify the most cost-effective production environment configuration that meets the performance goals of a production environment. For example, a modified simulated annealing algorithm may identify a cost-effective configuration that has a performance measure value that does not exceed the received maximum value associated with the performance measure.

In an embodiment, a modified simulated annealing algorithm may evaluate one or more performance measures via simulation. The algorithm may use a cooling schedule and may use all observations obtained at a particular point in time to estimate a performance measure.

In an embodiment, a solution may be considered feasible if it has a performance measure value that does not exceed the received maximum value associated with the performance measure. To test feasibility at a current iteration, an arbitrary stochastic constraint, g(θ)≦δ, may be considered where g(θ) is the simulation output for design θ and δ represents a maximum desirable value for a performance measure. Letting gᵢ(θ) denote the i^{th} simulation replication and running the simulation n times, the estimate for g(θ) may be determined over n replications as

$$\hat{g} ( θ ) = {\sum }_{i = 1}^{n} {g}_{i} ( θ ) / n ,$$

with the variance of ĝ(θ) represented by

$${Var}_{\hat{g} ( θ )} = {\sum }_{i = 1}^{n} {g}_{i} ( θ ) - {\hat{g} ( θ )}^{2} / n - 1.$$

The feasibility conditions may be represented as follows:

H₀: ĝ(θ)<=δ

H₁: ĝ(θ)>δ

In an embodiment, H₀ may be accepted if

ω=ĝ(δ)+t_{n-1,1-α}×\hat{σ}_{ĝ(δ)}/\sqrt{n}≦δ

### Where:

n−1 is the degrees of freedom,

1−α is the upper critical point for the t distribution

\hat{σ}_{ĝ}(θ) denotes the standard deviation of ĝ(θ)

In an embodiment, the search space, S, may be a set of design configurations whose cardinality is represented by

$${( ub - l b + 1 )}^{{\sum }_{i = 1}^{C} {n}_{i}} .$$

For each Xₖ∈S, there exists a subset N(θ) of S−{Xₖ} which may be referred to as the set of neighbors of Xₖ, such that each point in N(θ) can be reached from Xₖ in a single transition.

In an embodiment, example annealing parameters may be as follows:
Number of times to run the simulations at design (Xₖ): n
Temperature depth: T_{depth}
Temperature decay rate: r
Maximum desirable level of secondary performance measure: δ
Number of times to search a neighborhood solution at a given temperature: L

The following pseudo-code illustrates an example method of performing 212 a modified simulated annealing algorithm according to an embodiment.

| | |
|---|---|
| STEP 1. | Set: feasibility = false |
| STEP 2. | Begin Loop: While feasibility = = false |
| STEP 3. | Obtain Initial Design Configuration: Xᵢ ∈ S |
| STEP 4. | Generate observations {f₀ (Xᵢ)}ⱼ₌₁ⁿ, {f₁ (Xᵢ)}ᵢ₌₁ⁿ |
| STEP 5. | $Evaluate : {\hat{f}}_{a} ( {X}_{i} ) {,}^{\hat{{f}_{1}} ( {X}_{i} ) , {\hat{ σ}}_{{\hat{f}}_{a} ( {X}_{i} )} , {\hat{ σ}}_{{\hat{f}}_{1} ( {X}_{i} )} and {t}_{n - 1 , 1 - α}}$ |
| STEP 6. | IF ω ≦ δ Then feasibility = true |
| STEP 7. | End Loop |
| STEP 8. | Set: value = \hat{f}₀ (Xᵢ), Tᵢₙᵢₜᵢₐₗ = value/2, T_{final} = Tᵢₙᵢₜᵢₐₗ/T_{depth} |
| STEP 9. | Begin Loop: While T ≧ T_{final} |
| STEP 10. | Set: value_{old} = value |
| STEP 11. | Begin Loop: do j = 1 . . . L |
| STEP 12. | Set: feasibility = false |
| STEP 13. | Obtain Neighborhood Design: |
| | Xⱼ ∈ N(Xᵢ), where N(θ) is the set of neighborhood of θ, θ ∈ S |
| STEP 14. | Generate observations {f₀ (Xⱼ)}ⱼ₌₁ⁿ, {f₁ (Xⱼ)}ⱼ₌₁ⁿ |
| STEP 15. | $Evaluate : {\hat{f}}_{a} ( {X}_{j} ) {,}^{\hat{{f}_{1}} ( {X}_{j} ) , {\hat{ σ}}_{{\hat{f}}_{a} ( {X}_{j} )} , {\hat{ σ}}_{{\hat{f}}_{1} ( {X}_{j} )} and {t}_{n - 1 , 1 - α}}$ |
| STEP 16. | IF ω ≦ δ Then feasibility = true |
| STEP 17. | IF feasibility = = true Then |
| STEP 18. | value_{new} = \hat{f}₀ (Xⱼ) |
| STEP 19. | Evaluate: delta = value_{new} − value and generate Uₖ~U[0, 1] |
| STEP 20. | IF delta < 0 OR e^{-delta/T} ≧ Uₖ then value = value_{new} and Xᵢ = Xⱼ |
| STEP 21. | End IF |
| STEP 22. | End IF |
| STEP 23. | End IF |
| STEP 24. | Next j |
| STEP 25. | End Loop |
| STEP 26. | T = r × T |
| STEP 27. | End Loop |
| STEP 28. | Return Optimum Design Configuration: Xᵢ⁻ = Xᵢ |
| STEP 29. | Return Optimum Value: \hat{f}₀ (Xᵢ⁻) |
| STEP 30. | End |

In an embodiment, a configuration may be identified 214. A configuration may be identified 214 based on one or more results of a random search technique. In an embodiment, the identified configuration may be presented 216 to a user. For example, an identified configuration may be displayed to a user on a display device, may be emailed to a user and/or otherwise presented to a user.

In an embodiment, the systems described in this disclosure may be implemented as a standalone solution. Alternatively, the systems may be implemented as a web-based or cloud-based solution. Although annealing is described as a search technique in this disclosure, it is understood that other random search techniques may be used within the scope of this disclosure.

The following illustrates methods of selecting an optimal production device configuration using three example problems. For each illustrative problem, the total station fixed cost is the objective function, and is defined as a linear function of production device costs ƒ₀(Xₖ)=Cᵢ×X_{ij′}, where Cᵢ is the fixed cost of the ith station, and Xᵢⱼ is the number of ith type of production device in the j^{th} cell. An example production environment may be a print shop having two cells and six stations. Table 1 illustrates example numerical range, type and cost information for each production device according to an embodiment.

TABLE 1

| Cell | Station | Min | Max | Fixed |
|---|---|---|---|---|
| Name | Name | No. (lb) | No. (ub) | Cost (C) |
| Cell One | Printer A | 1 | 3 | 2448874 |
| Cell One | Inserter A | 1 | 3 | 423366 |
| Cell One | Inserter B | 1 | 3 | 1443304 |
| Cell One | Printer B | 1 | 3 | 2448874 |
| Cell Two | Printer C | 1 | 3 | 3000000 |
| Cell Two | Inserter B | 1 | 3 | 1443304 |

Assuming 2,692 jobs having different workflows arrive over a time period, the total number of production device configurations (S) may be determined using the following equation:

$$\begin{matrix}{\prod }_{j = 1}^{W} {\prod }_{i = 1}^{{n}_{j}} ( {x}_{ij} + 1 ) = ( 2 + 1 ) \times ( 2 + 1 ) \times ( 2 + 1 ) \times \\ ( 2 + 1 ) \times ( 2 + 1 ) \times ( 2 + 1 ) \\ = 729\end{matrix}$$

where

Xᵢⱼ is the number of ith type of production device in the jth cell, which is equal to the difference of the upper and lower bounds;

Nⱼ is the number of stations per cell;

W is the number of cells in the production environment;

j is the cell index;

i is the station index;

Table 2 illustrates example production device configurations according to an embodiment.

TABLE 2

| | | | | Number | Number | Number |
|---|---|---|---|---|---|---|
| | | | | of | of | of |
| | | | | Printer | Printer | Inserter |
| | Number of | Number of | Number of | B | C | B |
| | Printer A | Inserter A | Inserter B | stations | stations | stations |
| Design | stations in | stations in | stations in | in Cell | in Cell | in Cell |
| No. | Cell One | Cell One | Cell One | One | Two | Two |
| 1 | 1 | 1 | 1 | 1 | 1 | 1 |
| 2 | 1 | 1 | 1 | 1 | 1 | 2 |
| 3 | 1 | 1 | 1 | 1 | 1 | 3 |
| 4 | 1 | 1 | 1 | 1 | 2 | 1 |
| . | . | . | . | . | . | . |
| . | . | . | . | . | . | . |
| . | . | . | . | . | . | . |
| 728 | 3 | 3 | 3 | 3 | 3 | 2 |
| 729 | 3 | 3 | 3 | 3 | 3 | 3 |

### Problem 1

In this problem, average turnaround time (Avg TAT) less than or equal to five hours is the production environment performance goal. Table 3 illustrates the optimal and/or near optimal production device configuration and the associated total station cost obtained from a manual selection procedure for N, which represents the number of simulations to run each design configuration. In this problem, N=30.

TABLE 3

| | First best | Second best | Third best |
|---|---|---|---|
| | solution | solution | solution |
| Number of Printer A stations | 1 | 1 | 1 |
| in Cell One | | | |
| Number of Inserter A stations | 1 | 2 | 3 |
| in Cell One | | | |
| Number of Inserter B stations | 3 | 3 | 3 |
| in Cell One | | | |
| Number of Printer B stations | 1 | 1 | 1 |
| in Cell One | | | |
| Number of Printer C stations | 1 | 1 | 1 |
| in Cell Two | | | |
| Number of Inserter B stations | 2 | 2 | 2 |
| in Cell Two | | | |
| Optimal Total Station Cost | 15537634 | 15961000 | 16384366 |

| | |
|---|---|
| Number of Simulations | 21870 |
| Time in Hours | 29.94 |

In comparison, Table 4 illustrates the optimal and/or near optimal production device configuration and the associated total station cost obtained from automatic selection procedure using the following simulated annealing parameters:

n=5

L=5

T_{depth}=100

r=0.9

significance value for t-test α=0.01 for three different simulated annealing runs

TABLE 4

| | Run 1 | Run 2 | Run 3 |
|---|---|---|---|
| Number of Printer A stations | 1 | 1 | 1 |
| in Cell One | | | |
| Number of Inserter A stations | 1 | 1 | 2 |
| in Cell One | | | |
| Number of Inserter B stations | 3 | 3 | 3 |
| in Cell One | | | |
| Number of Printer B stations | 1 | 1 | 1 |
| in Cell One | | | |
| Number of Printer C stations | 1 | 1 | 1 |
| in Cell Two | | | |
| Number of Inserter B stations | 2 | 2 | 2 |
| in Cell Two | | | |
| Optimal Total Station Cost | 15537634 | 15537634 | 15961000 |
| Number of Simulations | 1120 | 1115 | 1115 |
| Time in Hours | 1.44 | 1.66 | 1.47 |

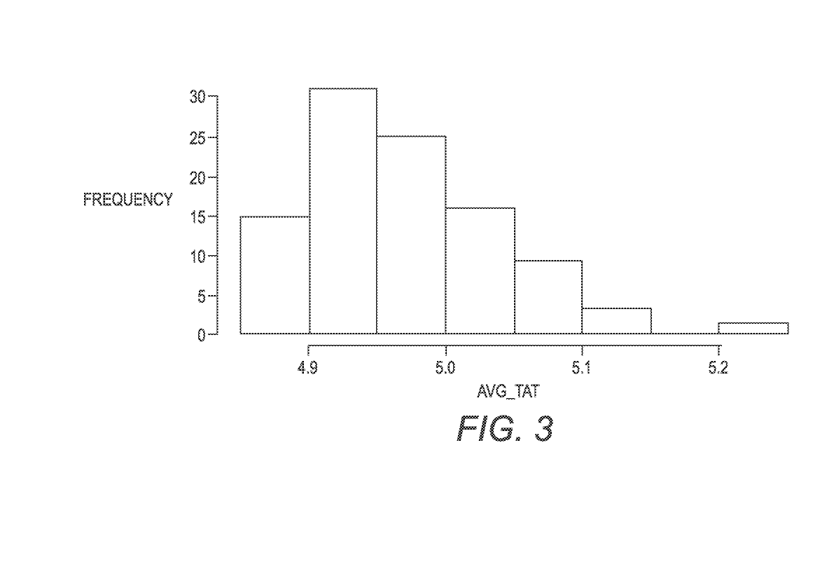

FIG. 3 illustrates an example histogram of the average TAT for the first best solution.

### Problem 2

In this problem, maximum turnaround time (Max TAT) less than or equal to twenty-four hours is the production environment performance goal. Table 5 illustrates the optimal and/or near optimal production device configuration and the associated total station cost obtained from a manual selection procedure for N=30.

TABLE 5

| | First best | Second best | Third best |
|---|---|---|---|
| | solution | solution | solution |
| Number of Printer A stations | 1 | 1 | 1 |
| in Cell One | | | |
| Number of Inserter A stations | 1 | 2 | 3 |
| in Cell One | | | |
| Number of Inserter B stations | 2 | 2 | 2 |
| in Cell One | | | |
| Number of Printer B stations | 1 | 1 | 1 |
| in Cell One | | | |
| Number of Printer C stations | 2 | 2 | 2 |
| in Cell Two | | | |
| Number of Inserter B stations | 2 | 2 | 2 |
| in Cell Two | | | |
| Optimal Total Station Cost | 17094330 | 17517696 | 17941062 |

| | |
|---|---|
| Number of Simulations | 21870 |
| Time in Hours | 29.94 |

In comparison, Table 6 illustrates the optimal and/or near optimal production device configuration and the associated total station cost obtained from automatic selection procedure using the following simulated annealing parameters:

n=5

L=5

T_{depth}=100

r=0.9

significance value for t-test α=0.01 for three different simulated annealing runs

TABLE 6

| | Run 1 | Run 2 | Run 3 |
|---|---|---|---|
| Number of Printer A stations | 1 | 1 | 1 |
| in Cell One | | | |
| Number of Inserter A stations | 1 | 1 | 1 |
| in Cell One | | | |
| Number of Inserter B stations | 2 | 2 | 2 |
| in Cell One | | | |
| Number of Printer B stations | 1 | 1 | 1 |
| in Cell One | | | |
| Number of Printer C stations | 2 | 2 | 2 |
| in Cell Two | | | |
| Number of Inserter B stations | 2 | 2 | 2 |
| in Cell Two | | | |
| Optimal Total Station Cost | 17094330 | 17094330 | 17094330 |
| Number of Simulations | 1140 | 1115 | 1135 |
| Time in Hours | 1.59 | 1.51 | 1.54 |

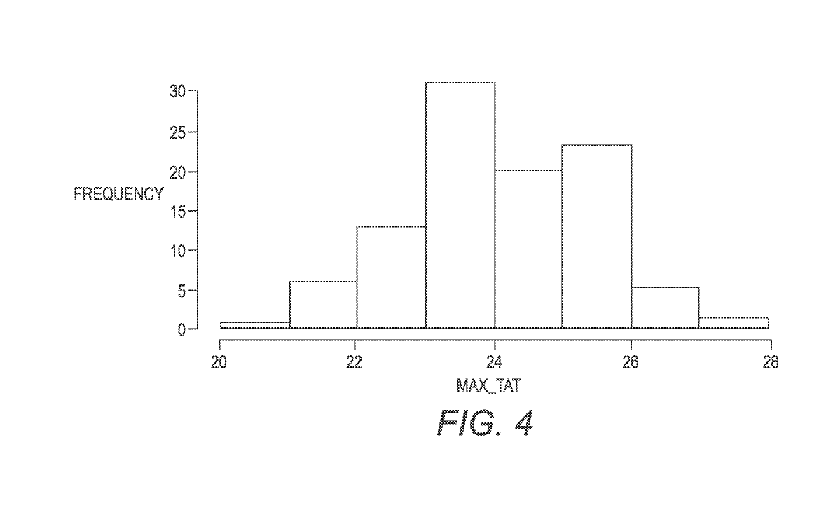

FIG. 4 illustrates an example histogram of the maximum TAT for the first best solution.

### Problem 3

In this problem, the number of late jobs less than or equal to zero hours is the production environment performance goal. Table 7 illustrates the optimal and/or near optimal production device configuration and the associated total station cost obtained from a manual selection procedure for N=30.

TABLE 7

| | First best | Second best | Third best |
|---|---|---|---|
| | solution | solution | solution |
| Number of Printer A stations | 1 | 1 | 1 |
| in Cell One | | | |
| Number of Inserter A stations | 2 | 3 | 1 |
| in Cell One | | | |
| Number of Inserter B stations | 2 | 2 | 2 |
| in Cell One | | | |
| Number of Printer B stations | 1 | 1 | 1 |
| in Cell One | | | |
| Number of Printer C stations | 2 | 2 | 2 |
| in Cell Two | | | |
| Number of Inserter B stations | 2 | 2 | 3 |
| in Cell Two | | | |
| Optimal Total Station Cost | 17517696 | 17941062 | 18537634 |

| | |
|---|---|
| Number of Simulations | 21870 |
| Time in Hours | 29.94 |

In comparison, Table 8 illustrates the optimal and/or near optimal production device configuration and the associated total station cost obtained from automatic selection procedure using the following simulated annealing parameters:

n=5

L=5

T_{depth}=100

r=0.9

significance value for t-test α=0.01 for three different simulated annealing runs

TABLE 8

| | Run 1 | Run 2 | Run 3 |
|---|---|---|---|
| Number of Printer A stations | 1 | 1 | 1 |
| in Cell One | | | |
| Number of Inserter A stations | 1 | 1 | 3 |
| in Cell One | | | |
| Number of Inserter B stations | 2 | 3 | 2 |
| in Cell One | | | |
| Number of Printer B stations | 1 | 1 | 1 |
| in Cell One | | | |
| Number of Printer C stations | 2 | 2 | 2 |
| in Cell Two | | | |
| Number of Inserter B stations | 3 | 2 | 2 |
| in Cell Two | | | |
| Optimal Total Station Cost | 18537634 | 18537634 | 17941062 |
| Number of Simulations | 1105 | 1115 | 1120 |
| Time in Hours | 1.77 | 1.56 | 1.50 |

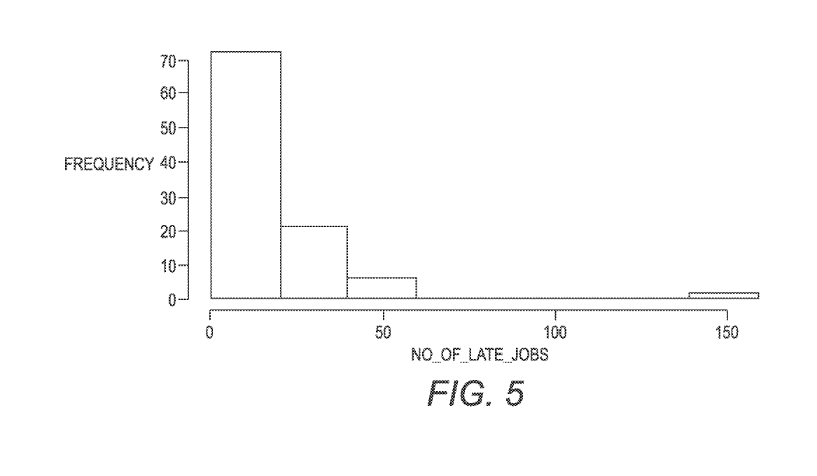

FIG. 5 illustrates an example histogram of the number of late jobs for the first best solution, which is non-normally distributed. The median is used as an estimator for the performance measure.

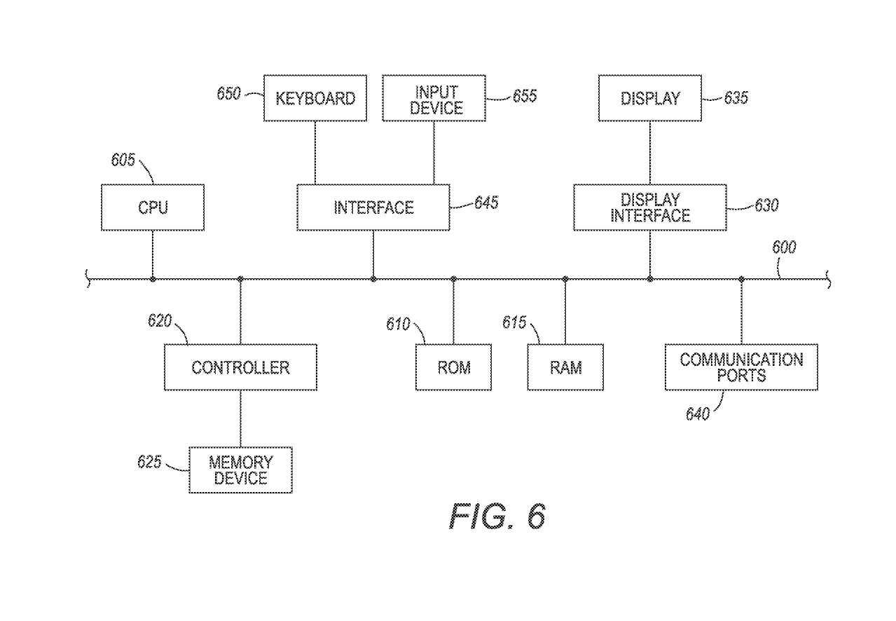

FIG. 6 depicts a block diagram of hardware that may be used to contain or implement program instructions. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an example of a production device, computing device or processor as such terms are used within this disclosure. Read only memory (ROM) 610 and random access memory (RAM) 615 constitute examples of non-transitory computer-readable storage media.

A controller 620 interfaces with one or more optional non-transitory computer-readable storage media 625 to the system bus 600. These storage media 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices, such as a printing device, may occur using various communication ports 640. A communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of determining a configuration of production devices in a print production environment, the method comprising:
receiving, by a computing device, one or more production environment characteristics associated with a print production environment;
receiving job processing information;
identifying, by the computing device, a performance measure;
receiving a desired value associated with the identified performance measure;
receiving one or more parameters associated with a random search algorithm; and
performing, by the computing device, the random search algorithm based on at least the received job processing information and the received parameters to determine a configuration of production devices in the print production environment that satisfies the desired value associated with the performance measure.

2. The method of claim 1, further comprising presenting, by the computing device, the determined configuration to a user.

3. The method of claim 1, wherein receiving one or more production environment characteristics associated with a print production environment comprises receiving one or more of the following:
a number of production devices in the print production environment;
one or more types of production devices;
a numerical range associated with one or more production device types; and
one or more setup characteristics.

4. The method of claim 1, wherein receiving job processing information comprises receiving information associated with one or more jobs to be processed by the print production environment.

5. The method of claim 4, wherein receiving information associated with one or more jobs to be processed by the print production environment comprises receiving one or more of the following:
a job type;
a job volume; and
one or more operating policies associated with the print production environment.

6. The method of claim 1, wherein performing the random search algorithm comprises performing a modified simulated annealing algorithm.

7. A system of determining a configuration of production devices in a print production environment, the system comprising:
a computing device; and
a computer-readable storage medium in communication with the computing device, wherein the computer-readable storage medium comprises one or more programming instructions that, when executed, cause the computing device to:
receive one or more production environment characteristics associated with a print production environment,
receive job processing information,
identify a performance measure,
receive a desired value associated with the identified performance measure,
receive one or more parameters associated with a random search algorithm, and
perform the random search algorithm based on at least the received job processing information and the received parameters to determine a configuration of production devices in the print production environment that satisfies the desired value associated with the performance measure.

8. The system of claim 7, wherein the computer-readable storage medium further comprises one or more programming instructions that, when executed, cause the computing device to present the determined configuration to a user.

9. The system of claim 7, wherein the one or more programming instructions that, when executed, cause the computing device to receive one or more production environment characteristics associated with a print production environment comprise one or more programming instructions that, when executed, cause the computing device to receive one or more of the following:
a number of production devices in the print production environment;
one or more types of production devices;
a numerical range associated with one or more production device types; and
one or more setup characteristics.

10. The system of claim 7, wherein the one or more programming instructions that, when executed, cause the computing device to receive job processing information comprise one or more programming instructions that, when executed, cause the computing device to receive information associated with one or more jobs to be processed by the print production environment.

11. The system of claim 10, wherein the one or more programming instructions that, when executed, cause the computing device to receive information associated with one or more jobs to be processed by the print production environment comprise one or more programming instructions that, when executed, cause the computing device to receive one or more of the following:
a job type;
a job volume; and
one or more operating policies associated with the print production environment.

12. The system of claim 7, wherein the one or more programming instructions that, when executed, cause the computing device to perform the random search algorithm comprises one or more programming instructions that, when executed, cause the computing device to perform a modified simulated annealing algorithm.

13. A system of determining a configuration of production devices in a print production environment, the system comprising:
a computing device; and
a computer-readable storage medium in communication with the computing device, wherein the computer-readable storage medium comprises one or more programming instructions that, when executed, cause the computing device to:
receive one or more production environment characteristics associated with a print production environment,
receive job processing information,
receive one or more parameters associated with a random search algorithm,
perform the random search algorithm using a plurality of simulations to determine one or more performance measures based on at least the received job processing information and the received parameters, and
determining, based on the one or more performance measures, a configuration of production devices in the print production environment that satisfies one or more desired values associated with the one or more performance measures.

14. The system of claim 13, wherein the computer-readable storage medium further comprises one or more programming instructions that, when executed, cause the computing device to present the determined configuration to a user.

15. The system of claim 13, wherein the one or more programming instructions that, when executed, cause the computing device to receive one or more production environment characteristics associated with a print production environment comprise one or more programming instructions that, when executed, cause the computing device to receive one or more of the following:
a number of production devices in the print production environment;
a numerical range associated with one or more production device types;
one or more types of production devices; and
one or more setup characteristics.

16. The system of claim 13, wherein the one or more programming instructions that, when executed, cause the computing device to receive job processing information comprise one or more programming instructions that, when executed, cause the computing device to receive information associated with one or more jobs to be processed by the print production environment.

17. The system of claim 16, wherein the one or more programming instructions that, when executed, cause the computing device to receive information associated with one or more jobs to be processed by the print production environment comprise one or more programming instructions that, when executed, cause the computing device to receive one or more of the following:
a job type;
a job volume; and
one or more operating policies associated with the print production environment.

18. The system of claim 13, wherein the one or more programming instructions that, when executed, cause the computing device to perform the random search algorithm comprises one or more programming instructions that, when executed, cause the computing device to perform a modified simulated annealing algorithm.
